(19) United States
(12) Patent Application Publication
(10) Pub. No.: US 2015/0118124 A1
(43) Pub. Date: Apr. 30, 2015

(54) STRUCTURAL COLORIMETRIC SENSOR

(71) Applicants: Mohammadreza Khorasaninejad, Waterloo (CA); Jaspreet Walia, Kitchener (CA); Simarjeet Saini, Waterloo (CA)

(72) Inventors: Mohammadreza Khorasaninejad, Waterloo (CA); Jaspreet Walia, Kitchener (CA); Simarjeet Saini, Waterloo (CA)

(21) Appl. No.: 14/398,780

(22) PCT Filed: May 13, 2013
(86) PCT No.: PCT/CA2013/050366

§ 371 Date: Nov. 4, 2014

Related U.S. Application Data
(60) Provisional application No. 61/646,288, filed on May 12, 2012.
(60) Provisional application No. 61/797,260, filed on Dec. 3, 2012.

(51) Int. Cl. G01N 21/25; G01N 21/78

(52) U.S. Cl. CPC G01N 21/251; G01N 21/78; G01N 2201/061
USPC 422/429; 422/426

(57) ABSTRACT

A colorimetric sensor including: a substrate; and a periodic array of nanostructures provided to the substrate, wherein the periodic array of nanostructures is configured to provide a change in color based on a medium being within a predetermined distance of the colorimetric sensor. The periodic array of nanostructures may be configured (width, height, spacing) to provide optical wave-guide properties or surface Plasmon resonance in order to effect a distinct change in color based on the medium being sensed. In some cases, the colorimetric may include a reflective surface to reflect light from the sensor. Further, the reflective surface may be metallic.

### CROSS REFERENCE TO RELATED APPLICATIONS

This application claims the benefit of priority of U.S. Provisional Patent Application No. 61/646,288 filed May 12, 2012, and U.S. Provisional Patent Application No. 61/797,260 filed Dec. 3, 2012, which are incorporated herein by reference in their entirety.

### FIELD

The present disclosure relates generally to structural colorimetric sensors. More particularly, the present disclosure relates to sensors with nanostructures using color as an indicator of a sensed value.

### BACKGROUND

Different types of sensors are useful in a wide variety of applications in order to provide information about one or more characteristics of the environment or objects within the environment. One type of sensor is a colorimetric sensor, that is, a sensor that exhibits a color change based on the one or more characteristics of the environment or objects within the environment. A simple example is a litmus test strip that changes color based on the acidity of its environment.

Conventional sensors using color are generally not used for applications such as sensing refraction index and surface characteristics. Even when used, such sensors typically require advanced image processing techniques, including spectral analysis, in order to analyze a sensed result.

It is therefore desirable to provide an improved structural colorimetric sensor for use in various applications and, in particular, sensing refraction index and surface characteristics.

### SUMMARY

It is an object of the present disclosure to obviate or mitigate at least one disadvantage of conventional sensors.

According to an aspect herein, there is provided a colorimetric sensor including: a substrate; and a periodic array of nanostructures provided to the substrate, wherein the periodic array of nanostructures is configured to provide a change in color based on a medium that is within a predetermined distance of the colorimetric sensor.

While periodic arrays or refraction gratings have been used for filters and other optical effects, it is believed that such periodic arrays have not been used as a colorimetric sensor of the type contemplated herein. That is, a sensor that changes color depending on the medium on or around the sensor.

In a particular case, the periodic array of nanostructures may include semiconductor nanowires. In this case, the providing a change in color may result from optical wave-guiding in the semiconductor nanowires.

In another particular case, the periodic array of nanostructures may include a metallic refraction grating formed by metallic nanostructures. In this case, the providing a change in color may result from surface Plasmon resonance among the periodic array of nanostructures. Also in this case, the providing a change in color may result from a dip in the reflection spectrum at a predetermined wavelength based on characteristics of the periodic array of nanostructures.

In yet another particular case, the colorimetric sensor may be transmissive. It will be understood that the colorimetric sensor may be configured such that light passes through (transmissive) or such that light is reflected back from the sensor (reflective). In some cases, the sensor may include a range of both properties.

According to another aspect herein, there is provided a colorimetric sensor including: a substrate; a reflective surface provided to the substrate; and a periodic array of nanostructures provided to the reflective surface, wherein the periodic array is configured to provide a change in reflected color based on a medium within a predetermined distance of the colorimetric sensor.

In a particular case, the periodic array may be formed of metallic nanostructures. In this case, the providing a color change may result from surface Plasmon resonance among the periodic array of metallic nanostructures. Also in this case, the providing a color change may result from a dip in the reflection spectrum at a predetermined wavelength based on characteristics of the periodic array of nanostructures. In a particular example of this case, the nanostructures may have a spacing in a range of approximately 250 nm to 750 nm and a width in a range of approximately 20% to 80% of the spacing. Further, the nanostructures may have a height in a range of approximately 30 nm to 300 nm or in a range of approximately 70 nm to 100 nm.

In this particular case, the periodic array may be configured such that a color resulting from the change in reflected color is visible to the naked eye. Alternatively, the periodic array may be configured such that a color resulting from the change in reflected color is at a wavelength between approximately 500 nm and 700 nm.

In another particular case, the predetermined distance may be less than approximately 100 nm or alternatively less than approximately 50 nm.

In yet another particular case, the reflective surface may be metallic and provide a π (pi) phase shift.

In still yet another particular case, the reflective surface may be placed on the substrate and the periodic array of nanostructures may be placed on the reflective surface in order to provide vivid colors and color changes.

According to another aspect herein, there is provided a colorimetric sensor including: a substrate; a metallic reflective surface provided to the substrate; and a periodic grid of nanostructures provided to the reflective surface, wherein the periodic grid has a spacing of approximately 400 nm and the nanostructures have a width of approximately 150 nm. Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 illustrates an SEM image taken at an angle of 45° of a nanowire array;

FIG. 2A is a graph illustrating reflections from SiNW array for three different diameters for p-polarized input and FIG. 2B is a graph illustrating s-polarized input.

FIG. 3 is a graph illustrating reflection from semi-infinitely long silicon nanowires for different diameters;

FIGS. 4A to 4C illustrates electric field distributions for diameters of semi-infinitely long nanowires and FIGS. 4D to 4F illustrate electric field distribution for diameters of 1 μm long nanowires on the SOI wafer;

FIG. 5 illustrates bright-filed microscopic images of four different diameters as the refractive index of the surrounding medium is changed;

FIGS. 6A to 6C are graphs illustrating color components for nanowires with diameter of 150 nm for R, G, and B values from the reflected colors as the refractive index of the surrounding medium is changed; FIG. 6D is a graph illustrating color value over 8 independent experiments;

FIG. 7 is a graph illustrating a sensitivity and index resolution as a function of diameter for the nanowire arrays;

FIG. 8 is a graph illustrating R, G, and B values versus temperature change for the array consisting of nanowires with a diameter of 150 nm;

FIG. 9A illustrates gold nano-patch grating on a substrate; FIG. 9B illustrates Unit cell of gold grating with periodic boundary condition in transverse direction;

FIGS. 9C and 9D show top view SEM images of 320 nm and 200 nm gold grating on Al-coated glass substrate, respectively;

FIGS. 10A and 10B illustrate reflection from 200 nm wide gold nano-patch grating on glass, and on Al-coated glass respectively;

FIGS. 11A to 11C illustrate amplitude of total electric field in x-z plane for wavelength of 400 nm for FIG. 11A, 566 nm for FIG. 11B and 714 nm for FIG. 11C; FIGS. 11D to 11F illustrates amplitude of total magnetic field in y-z plane for wavelength of 400 nm for FIG. 11D, 566 nm for FIG. 11E and 714 nm for FIG. 11F;

FIG. 12A is a graph illustration reflection for different patches with surrounding refractive index of 1.30; FIG. 12B is a graph showing wavelength for which the resonance occurs as the width is changed; FIG. 12C is a graph showing reflection from the patch with a width of 155 nm for different surrounding indices; FIG. 12D is a graph showing reflection from the patch with a width of 320 nm and different surrounding refractive indices.

FIG. 13 is bright-field images of different pads showing the dependency of reflected color to the refractive index of the surrounding medium.

FIG. 14A illustrates color change due to depositing different thicknesses of silicon dioxide; FIG. 14B is a graph showing the change of RGB values versus silicon dioxide thickness; FIG. 14C is a graph showing the change of CMYK versus silicon dioxide thickness;

FIG. 15 is a graph illustrating a comparison of the reflections calculated using RCWA and REM simulations;

FIGS. 16A and 16B are graphs showing reflection, absorption and transmission for 200 nm wide gold nano-patch with surrounding refractive index of 1 (air) on glass and Al-coated glass substrate respectively;

FIGS. 17A and 17B are graphs illustrating reflection, absorption and transmission for 200 nm wide gold nano-patch with surrounding refraction index of 1.30 on Al-coated glass substrate;

FIGS. 18A to 18C illustrates a total electric field distribution for a focused Gaussian beam input for incidence wavelength of 400 nm, 566 nm, and 714 nm respectively;

FIG. 19 is a simulated reflection spectrum for 230 nm wide nano-patches for different refractive indices of the surrounding medium overlaid on the visible spectrum; and

FIG. 20A is a graph illustrating the sensitivity versus nano-patch width and FIG. 20B is a graph illustrating the index resolution versus nano-patch width.

### DETAILED DESCRIPTION

Generally, the present disclosure provides for a structural colorimetric sensor and method of fabrication of the same. The sensors are intended to detect characteristics of a material of interest through reflecting and refracting different colors, through surface Plasmon resonance or optical wave-guiding through high refractive index materials, for example having a refractive index difference with air above approximately 1. The colors are intended to be vivid colors and may, in some cases, be visible by the naked eye. The sensors are intended to make use of nano devices which allow for refractive index sensing and surface sensing based on the changes in the reflected colors. In some cases, the sensors include silicon nanowires which may be electromagnetically coupled to each other. In other cases, the sensors include a two dimensional metallic grating array on a reflective surface.

In an embodiment of a structural colorimetric sensor, silicon nanowires having a diameter in a range from 105 to 346 nm are vertically arranged in a square lattice array with a pitch of approximately 400 nm. The silicon nanowires are electromagnetically coupled to each other, resulting in frequency-dependent reflection spectra, which can produce vivid colors. Since the coupling is dependent on the refractive index of the medium surrounding the nanowires, the arrays can be used for sensing. A simple sensor is demonstrated by observing the change in the reflected color with changing refractive index of the surrounding medium. In experiments, a refractive index resolution of 5×10⁻⁵ may be achieved by analyzing bright-field images captured with an optical microscope equipped with a charge coupled device camera.

In another embodiment of the structural colorimetric sensor, a two-dimensional grating array of gold nanostructures is arranged on a reflective surface, for example a metallic mirror. The mirror also provides a phase shift of π to the reflected light. It will be understood that although this embodiment refers to gold nano-structures or nano-particles, other metallic materials may be substituted. The grating on the reflective surface creates surface Plasmon resonance resulting in a dip in the visible reflection spectrum. The wavelength of the resonance can be tuned by changing, for example, the width of the nanostructures. In one particular example, the width may be in the range of approximately 120 nm to 260 nm based on a spacing of the nanostructures of approximately 400 nm. In order to provide light in the visible range, the spacing may be between approximately 250 nm and 750 nm and the nanostructures may be between 20% and 80% of the spacing. The height of the nanostructures appears to have less impact on the results but may be between approximately 30 nm and 300 nm, or in particular embodiments between approximately 70 nm and 100 nm.

The Plasmon resonance is sensitive to the refractive index of the surrounding medium such that a color variation due to change in the refractive index can be measured and used to realize a refractive index sensor. In some embodiments, experiments have shown a refractive index resolution of 3×10⁻⁶. The sensor may also be used for surface sensing due to color differences when a material is placed on the sensor. In an experiment, it was determined that color differences due to a 3 nm thick silicon dioxide layer are detectable by the naked eye and deposition thicknesses of 2 Å can be resolved using image processing.

Returning to silicon nanowires in more detail, silicon nanowires (SiNWs) have attracted a great deal of attention in recent years due to their ability to exhibit interesting physical properties not observed in bulk silicon. In particular, nanowires confine carriers and photons in the transverse plane while still allowing them to propagate in the longitudinal direction. Recently, SiNWs have been investigated for use as transistors, photo detectors, solar cells, and imagers. In all of these applications, SiNWs exhibit interesting material properties, such as reduced reflectivity over a wide band range, increased absorption due to light trapping, and the ability to band gap engineer the structures.

Nanowires also offer an increased surface-to-volume ratio, a property which can be used for sensing applications. Conventionally, this property has been used in porous silicon-based optical interferometric biosensors, evanescent wave optical sensors in which the evanescent field is increased by the use of SiNWs, and fluorescence sensors based on SiNWs. In all of these applications, an expensive measurement system is typically required involving spectrometers and tunable lasers, as these sensors work by means of measuring spectral changes in the presence of the detectants.

Another property of SiNWs involves reflecting vivid colors. This result has been observed in horizontal single SiNWs on a substrate which were excited with incident light normal to the nanowires. The vivid colors were a result of strong resonant light scattering due to the high refractive index mismatch between the SiNWs and the surrounding medium. Subsequently, colors with bright-field microscopy were also observed in vertical single SiNWs. The reflected colors resulted from the guided modes within the SiNWs coupling selectively with the substrate modes. In both cases, the colors were created by individual SiNWs with no coupling or diffractive effects. For the embodiments of the sensors described herein, vertical arrays are fabricated where the nanowires are electromagnetically coupled to each other, and vivid colors can be generated for coupled arrays.

In one embodiment, a refractive index sensor is provided within the nanowire arrays, capturing an image with a charge-coupled device (CCD) camera through a bright-field microscope, and analyzing the image for its red, green, and blue content using the RGB additive model, subtractive CMYK model or other image processing models. Using this calibration method, a refractive index resolution of 5×10⁻⁵ may be achieved which compares well with integrated optics based sensors. In experimentation using the nanowire sensor, the sensitivity to refractive index does not vary monotonically with the diameter of nanowire which strongly suggests that coupling plays a critical role in achieving these results. Furthermore, a low sensitivity to temperature was measured.

In this case, the nanowire arrays were fabricated through a top-down approach via electron beam lithography (EBL) and inductively coupled plasma reactive ion etching (ICP-RIE), using a pseudo-Bosch process although other methods of fabrication may be used. For this experiment, silicon on insulator (SOI) substrate with a 1.5 μm thick layer of silicon on top of a 3 μm thick silicon dioxide layer was used. An SOI wafer was chosen since, after etching the nanowires, the residual silicon below can behave as a slab waveguide, enhancing the substrate modes. This was intended to allow for another reflection at the silicon-oxide interface creating a coupled cavity with the silicon nanowires which was intended to result in sharp reflection features. The etch mask for the nanowire fabrication was created using EBL and a subsequent lift-off process. A 30 nm thick aluminum (Al) layer was used as the etch mask.

The nanowires were etched to a length of 1.0 μm with ICP-RIE in arrays of 100 μm×100 μm. The diameters were varied from 105 to 346 nm by changing the dosage in the EBL process. The nanowires were arranged in a square lattice with a pitch of 400 nm. A square lattice was chosen but it will be understood that other patterns may be used. For example, the nanowires may be arranged in a hexagonal lattice, a circular lattice or the like.

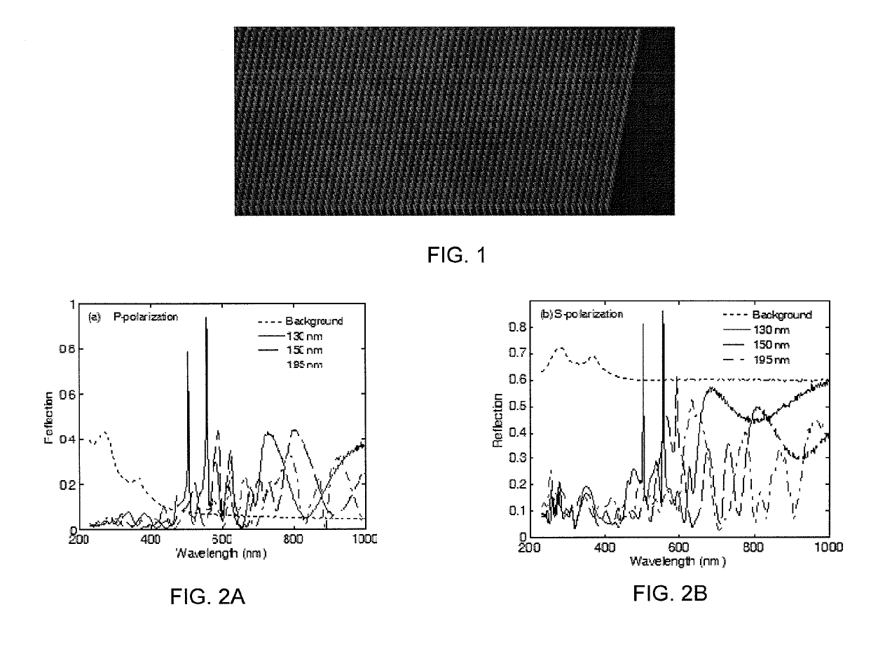

FIG. 1 shows the scanning electron microscope (SEM) image of the nanowire array. The SEM images illustrate the uniformity in the diameter and position of the nanowires along with the vertical nature, even for the highly packed nanowires. It will be understood that there is a diameter-length ratio above which the nanowires will remain vertical. For the experimental sensors, the diameter and length of the nanowires were chosen so the nanowires would be vertical. In testing, it was found that vivid colors covering the whole visible range could be obtained by changing the diameter of the nanowires.

FIGS. 2A and 2B are graphs that illustrate the reflection spectra for differing diameters of wire in light of both p- and s-polarizations, respectively. The reflections from a bulk silicon substrate are also shown for comparison. For p-polarized incident light as shown in FIG. 2A, the SiNW arrays exhibit higher reflections and display frequency selective features resembling Fabry-Perot modes above the wavelength of 450 nm as compared to bulk silicon. For the s-polarized input as shown in FIG. 2B, the reflections are generally lower than that of bulk silicon; however, some unique features are still observed. For example, for the diameter of 130 nm, an increase in reflection occurs above the wavelength of approximately 645 nm as compared to below this wavelength. Above this wavelength, reflections approach that of silicon. A similar behavior is observed for the 150 nm diameter nanowire, except the wavelength where this change happens is at approximately 780 nm. As the diameter is increased further to 195 nm, this transition is no longer observed. Additionally, multiple frequency bands in the reflection spectrum are observed where the peak separation corresponds to the Fabry-Perot modes of a 1 μm long cavity. As the diameter is increased, the number of these frequency bands also increases. For the diameter of 130 nm, very sharp resonance like spectral features was observed at wavelengths ˜504 nm and 556 nm for both s- and p-polarized inputs. For the diameter of 150 nm, similar sharp reflection peaks are observed around 592 nm. As the diameter is increased to 195 nm, these sharp features disappear. Since the reflection features are highly dependent on the diameter of SiNWs and vary significantly as diameter is changed, the sensitivity appears not to change monotonically with diameter. This result is considered to be in contrast to what one would expect for independent nanowires where the surrounding medium is only being interrogated by the evanescent fields.

Multiple reactions occurring within the nanowire arrays are believed to result in the features observed in the measured reflection spectra. First, the nanowire arrays act like a two-dimensional dielectric grating. SiNWs with residual silicon of the SOI wafer can support guided slab modes resulting in a resonant coupling between the incident wave and the guided modes. Due to the diffraction of light by the two-dimensional periodicity, coupling of the incident wave with guided modes can occur in any direction within the grating waveguide. This coupling has a resonant nature due to phase matching requirements. Different diffraction orders allow for the resonance to occur at different wavelengths. The reflection peaks can approach unity provided the material is loss-less. The reflection peaks may have a bandwidth of less than 2 nm.

The behavior of an array of SiNWs as a two-dimensional grating is believed to result in the sharp reflection peaks as seen in the 130 nm and the 150 nm diameter nanowires. SiNWs on bulk silicon do not support the guided modes because of the lower effective index, and hence, the experiment used the SOI wafer as the modes are guided within the unetched silicon slab. For wavelengths where this resonance is not achieved, the SiNWs may act like an effective index medium creating a Fabry-Perot cavity between the SiNW-air and the SiNW-silicon interfaces. However, near-field coupling between the neighboring nanowires can create another resonance effect. Similar coupling in photonic lattices has previously been investigated in vertical cavity surface emitting lasers (VCSELs) arrays for creating diffraction limited fields from multiple devices. To confirm the effect of coherent coupling, a finite difference time domain (FDTD) simulation over the entire wavelength range was performed. Since the optical properties of silicon vary over the wavelength range between the Fabry-Perot peaks, it becomes difficult to ascertain the role of coupling versus Fabry-Perot interferences in the reflection spectrum. Hence, in the first simulation the nanowires were considered to be semi-infinite by using a matched layer boundary at the bottom, allowing one to see the effect of the near field coupling between the nanowires.

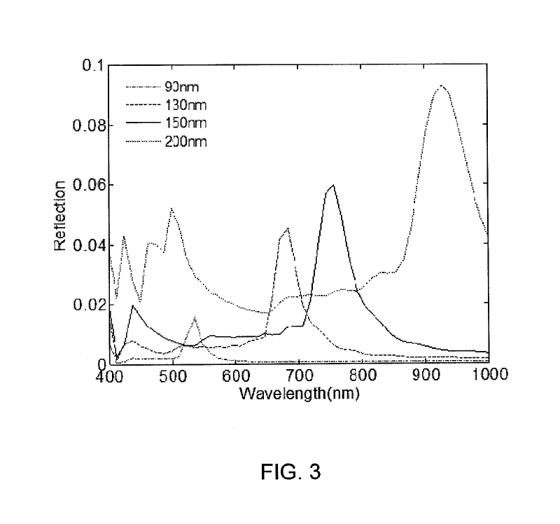

FIG. 3 is a graph which plots the simulated reflections from these nanowires as the diameter is changed. For all diameters, a peak in the reflection spectrum is seen, which changes in value and position depending on the diameter. As the diameter is increased, the intensity of the reflection peak increases and shifts toward longer wavelengths. Further, the reflection peak has a resonance-like bandwidth with full-width half-maximum values of ˜50 nm for diameters of 130 nm and 150 nm and ˜75 nm for the diameter of 200 nm. The peaks observed in the simulations exactly correspond to the wavelengths where the reflection sharply starts to approach that of bulk silicon are observed in the experimental s-polarized reflections. The resonant near field coupling increases the confinement of light within the SiNWs which may create a larger index mismatch, increasing the reflection from the array. The absorption within the nanowires also increases at the same place due to the increased confinement. Thus, the incident beam is better absorbed within the nanowires and sees less of the SiNW-Si interface.

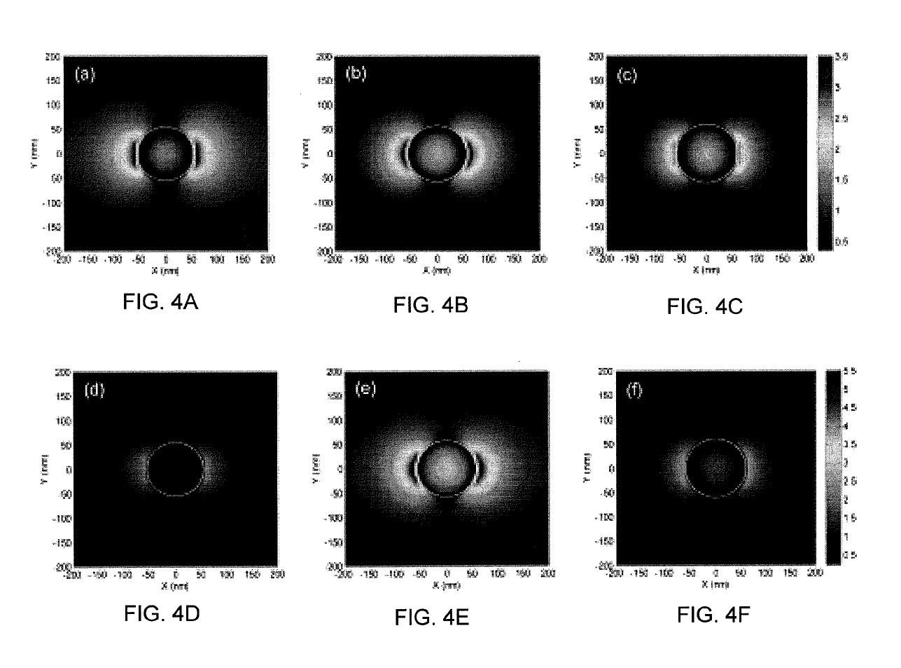

Since the reflection values from semi-infinite nanowires are generally small themselves, the reflection from the nanowire-silicon interface plays an important role in producing the observed spectrum. The effect of the Fabry-Perot modes created between the air-nanowire interface and nanowire-silicon interface was also simulated using the complete structure. The electric field distributions within the nanowires are shown in FIGS. 4D-4F, for three different diameters, for an incident wavelength of 630 nm. A very strong enhancement of the electric field is observed for the 115 nm diameter as compared to the diameters near this value.

The electric field distribution for the same diameters for semi-infinitely long nanowires is also shown in FIGS. 4A-4C. When the SiNWs are considered to be semi-infinite, the confinement of the light is again higher for the 115 nm diameter due to near field coupling, but the enhancement is not as large as when placed in a cavity. This strong enhancement results from the fact that, for this diameter, a Fabry-Perot mode has a maximum at the top of the nanowire, building up the intensity. At the same time, near field coupling has significantly enhanced the electric field within the nanowire. Hence, both the length and the diameter of the nanowires play an important role in producing the observed colors. To confirm this, two different lengths were fabricated, and the observed colors were only slightly different for the different lengths. Accordingly, the observed colors were determined to be mainly from the emergent optical properties of SiNWs arranged in an array.

An advantage of silicon nanowires is the large refractive index contrast with air. As such, if nanowires with lower refractive index materials like cadmium sulfide (CdS) are used, vivid colors may not be observed as readily. Also since the reflections over a broader wavelength range are due to the Fabry-Perot cavity created between the air-nanowire and the nanowire-silicon interfaces, the absorption of light within the nanowires also play a role in the reflection spectrum. Thus, for shorter wavelengths (<400 nm) where the absorption is high, the reflections are weak as seen previously in FIG. 2.

Within the structure, it was intended to create another resonance due to coupled-cavity among the SiNW-air, SiNW-Si, and Si-oxide interfaces. However, within the experimental data no Fabry-Perot modes from the Si-oxide interface were observed. This was confirmed by measuring the reflections from an area beside the arrays where only unetched silicon was present. The reflections observed were exactly the same as the bulk silicon. The reason for the lack of Fabry-Perot interferences may be due to the large surface roughness between the Si-oxide layers within the starting wafer.

The coupling between nanowires and the Fabry-Perot cavity is believed to create the sharp reflection features and the resultant colors. It was further envisioned that the reflection spectra will be dependent on the refractive index of the surrounding medium. If the change in color with the surrounding index medium could be measured, then a simple refractive index sensor with no costly optics could be considered. In order to quantify this, an experiment was conducted using Cargille refractive index fluids of known refractive indices ranging from 1.3 to 1.39. Cargille refractive index fluids contain chlorofluorocarbons with high stability and wettability to surfaces. Also, etched SiNWs have shown to have super-hydrophilic surfaces due to a hemiwicking phenomenon, provided the surface roughness is small, which is true in the current case, meaning the arrays could be used to test for a wide variety of different liquids. Additionally, excellent repeatability was achievable in connection with these fluids on etched optical fiber sensors.

The fluids were introduced in-between the nanowires. This range of the refractive index was chosen since the refractive index of water (1.33) and many other liquids of interest for biochemical sensing lie within these values.

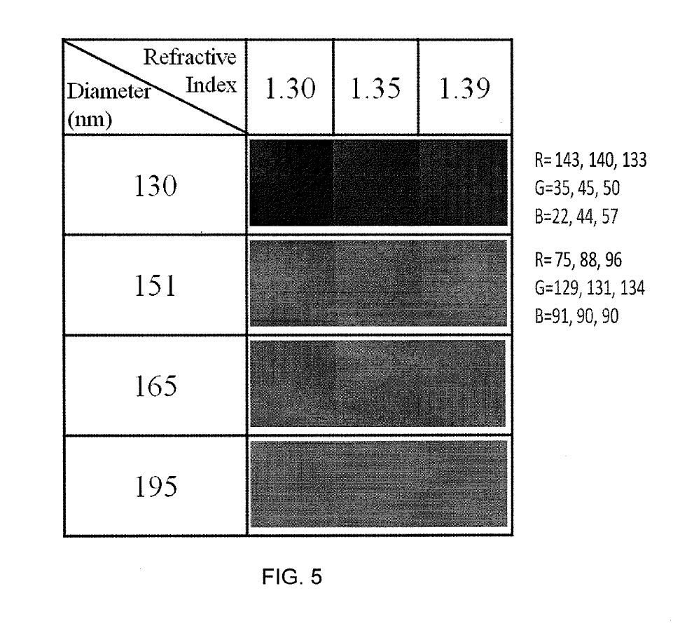

FIG. 5 plots the bright-field microscope images for four different arrays consisting of SiNWs with average diameters of 130 nm, 150 nm, 165 nm and 195 nm. Diameters of 130 nm and 150 nm displayed the sharp spectral peaks whereas for the diameters of 165 nm and 195 nm such features were not observed. As the refractive index of the surrounding fluid, and hence the surrounding medium changes, the corresponding variation in reflected color is clearly perceptible for the diameters of 130 nm and 150 nm, while the change is weak for the other two diameters. These results complement the experimental data where sharp reflection features were observed for the same SiNW diameters. Thus, by measuring the reflected colors using a standard camera, following by performing basic image processing, a refractive index sensor can be realized.

To quantify the sensitivity of the color change with the refractive index of the surrounding medium, the red (R), green (G), and blue (8) values were obtained using the additive RGB model, for the corresponding images of the arrays. Each combination of R, G, and 8 values represents a unique color. R, G, and 8 colors of the composite picture do not change in a predictable manner with diameter, which may be expected due to the resonances involved.

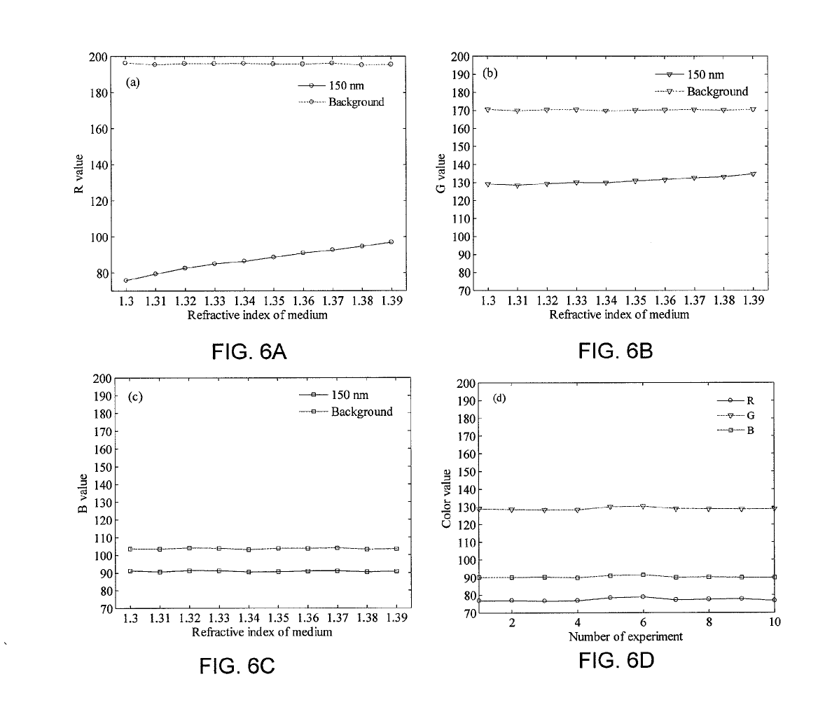

FIGS. 6A to 6C plots the change in R, G, and 8 values for an array of SiNWs with a diameter of 150 nm. The R, G, and 8 values from the background where there are no nanowires are also shown. This measurement was done to ensure that the observed color changes were not from the refractive index fluids themselves, but from the interaction of the liquid with the SiNW array. For this diameter, the R value changes linearly with increasing refractive indices, while G and 8 values do not change appreciably. It was also found that different arrays display different behavior in the changes of the R, G, and 8 components, with some arrays showing changes in all components.

Another experiment was also performed to gauge the repeatability of the measurement where a fluid with a refractive index of 1.3 was introduced to the nanowire arrays eight different times. The results for the same array are plotted in FIG. 6D. The ability to reproduce the colors from the arrays over multiple experimental trials suggests that the medium is conformally contacting the nanowire surfaces. If one only considers the R values for the diameter of 150 nm, then a refractive index resolution of 1×10⁻³ is achieved. However, since each combination of R, G and B defines a unique color, one should be able to increase the sensitivity by combining the changes in all of the three color values. To compare the different arrays, the changes in the values of R, G, and B (ΔR, ΔG, ΔB) from the reference value at 1.3 were computed, and the square of the changes was added together.

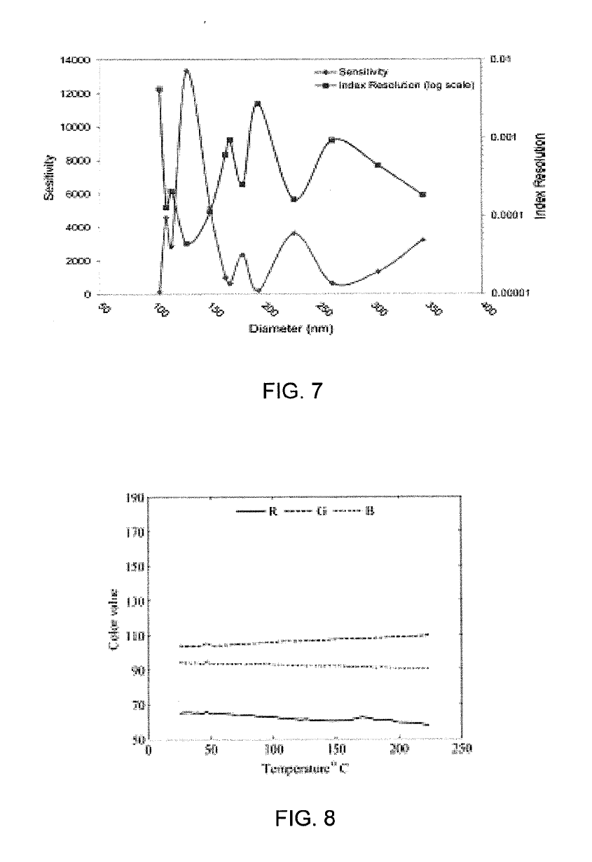

The sensitivity S is calculated as the slope of the change in color components with refractive index and is plotted in FIG. 7 for representative diameters. Using the standard deviation value from the repeatability measurements, the refractive index resolution was calculated as the ratio of twice the standard deviation and S, and this value is plotted in FIG. 7. The best refractive index resolution achieved was 5×10⁻⁵ for the array with 130 nm diameter nanowires. Both the 130 nm and 150 nm diameter SiNWs are able to achieve an index resolution of less than 1×10⁻⁴. This compares well with photonic based integrated circuit sensors with a sensitivity of 250 nm/RIU assuming a spectral resolution of 0.01 nm.

Once again, the arrays with the highest resolution (130 nm and 150 nm) also had the sharpest features in their corresponding reflection spectra. The resolution does not change monotonically which may be the case if the nanowires were acting individually. For example, the sensitivity degrades as the diameter is increased or decreased from 130 nm. For a diameter of 105 nm, the resolution is only 5×10⁻³, which effectively reduces the performance by 2 orders of magnitude when compared to 130 nm diameter nanowires. As the diameter is reduced, the evanescent field increases, and the sensitivity of the array would likely have increased if the nanowires were acting individually. By taking advantage of the coherent coupling between the nanowires, the sensitivity to color change has been increased, beyond what is conventionally expected from the evanescent fields alone.

The sensitivity of the color change with respect to temperature was measured by heating the sample to 225° C. and capturing images in steps of every ˜10° C., down to room temperature. The values of changes in the color components for a diameter of 150 nm are plotted in FIG. 8. Small variation in color is observed with temperature relative to the change with refractive index as plotted in FIG. 8, especially for values around room temperature. Thus, not only a good refractive index resolution is demonstrated with a simple camera; it has been further shown that the color change appears to be insensitive to temperature changes, especially for values around room temperature. Arrays with different diameters with lower refractive index changes showed a higher sensitivity to temperature changes. For the arrays with the highest sensitivity to refractive index (130 nm and 150 nm), the change in the values of R and G showed opposite trends. It was found that R changed with increasing refractive index, and G changed more with temperature. Thus, by using these components separately, changes in temperature and refractive index may be measured simultaneously.

Coupled vertical nanowire arrays reflect vivid colors similarly to single nanowires. Furthermore, by tuning the diameter, a strong electromagnetic coupling between the nanowires can be achieved, resulting in electric field enhancements within the array. The coupling effect was confirmed by measuring the polarization resolved reflections from the arrays, and corresponding FDTD simulations. The change in color was measured by introducing Cargille refractive index fluids, and a perceptible change in color to the naked eye was seen for coupled nanowire arrays. An index resolution of 5×10⁻⁵ was demonstrated by simply analyzing the images and adding the square of the changes in the values of the R, G, and B components for different refractive indices. Different diameters displayed remarkably different sensitivities to color change, again confirming the fact that coupling between the nanowires plays a key role, and the sensitivity does not monotonically vary with diameter. The color change with temperature was also measured and was found to be less sensitive as compared to observed changes in refractive index. The results suggest that vertical SiNW arrays can be used as platforms for refractive index sensors using a CCD camera.

Now turning to embodiments of the structural colorimetric sensors involving nanostructures arranged in periodic arrays. In some cases, the structural colorimetric sensor may be a one-dimensional or linear array of nanostructures. In other cases, the structural colorimetric sensor may be a two-dimensional or three-dimensional array of nanostructures. In these embodiments the nanostructures may be metallic structures and arranged in a periodic array configured to generate, i.e. reflect or transmit, colors due to excitation of localized surface Plasmon polaritons (SPP). Vivid colors from periodic metallic gratings may be used in image sensing. Such reflected and transmitted colors and their dependence on the surrounding medium are then used for embodiments of refractive index sensors for applications in bio-chemical sensing or the like.

In other embodiments, the structural colorimetric sensor may be configured as a refractive index sensor, again using periodic metallic nanostructures (in this case, gold square nanostructures, sometimes referred to as nano-patches) placed on a metallic mirror, rather than a dielectric substrate. The metallic mirror reflects the incident light with a 7C phase shift. This structure is intended to generate a strong localized resonating electric field within the area surrounding the nano-patches. By appropriate design of the size and spacing of the nano-patches and backside reflector, a highly sensitive stop-band filter may be achieved in the reflected visible spectrum. The stop-band filter creates a resonant dip in the reflection spectrum. The position of resonance is extremely sensitive to the refractive index of the surrounding medium.

In configuring the sensor, color changes can be tuned/varied by varying the geometric properties of the arrays. In particular, the geometrical parameters for the sensors can be used to tune the resonant dip, where maximum color change is perceived by the human eye, in the wavelength region of 500 nm to 700 nm. In some cases, the wavelength region will be between 580 nm and 600 nm. In a particular case, the wavelength region may be 589 nm. In some cases, a sensitivity of 532 nm/RIU can be obtained by measuring the reflection spectrum. In addition, an index resolution of ˜3×10⁻⁶ is demonstrated by measuring the changes in color using simple image processing. This index resolution is intended to be comparable to results obtained with typical high-Q photonic structures without requirement of expensive and complicated optics. Surface attachment sensing has also been demonstrated by depositing certain thicknesses of silicon dioxide, which has a refractive index close to that of biological and chemical elements, and perceptible color changes were observed by the naked eye when the thickness of silicon dioxide changed by only 3 nm. Using image processing and extracting the red, green and blue (RGB) and the cyan, magenta, yellow and key (CMYK) components of the images, depositions of 2 Å are detectable, strongly suggesting that the sensor can be used for bio-chemical sensing including hybridization of DNA and attachment of proteins. The color images were captured by simple bright-field microscopy without stringent alignment, which would typically be essential for imaging with diffractive orders of the two-dimensional gratings or expensive optics required for conventional planar light wave circuits or microcavity based sensing. The simple nature of sensing also lends itself to assay designs in future.

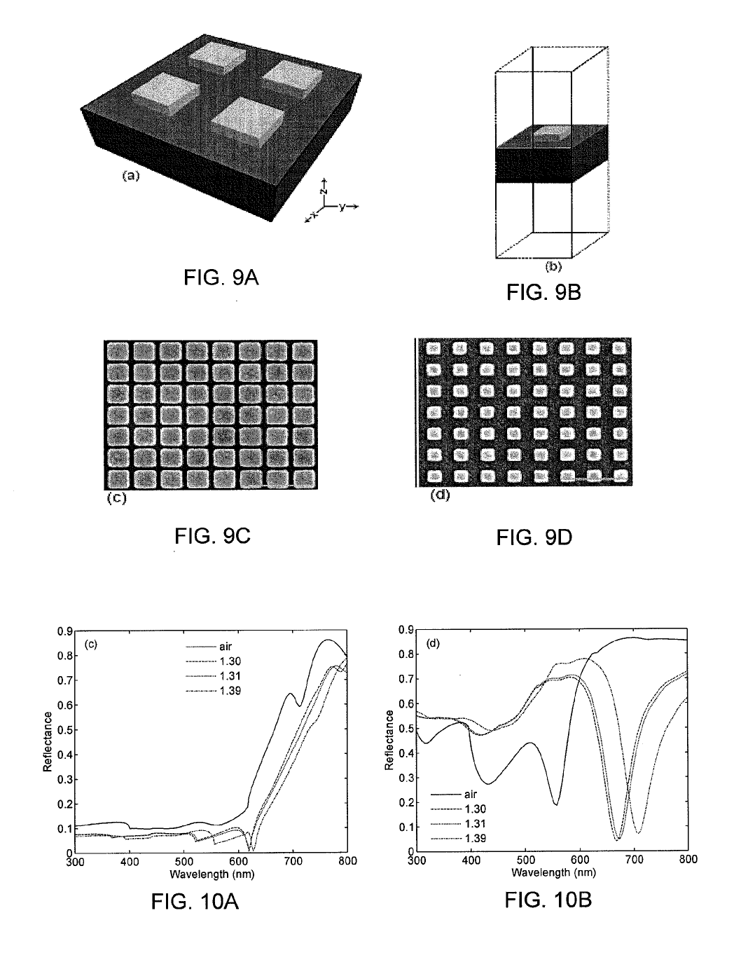

FIG. 9A shows a schematic diagram of a structural colorimetric sensor, consisting of a two-dimensional metallic nano-patch array. Gold nano-patches were fabricated and arranged in a periodic configuration such that the nano-patches created a surface Plasmon resonator. The structure was simulated with rigorous coupled wave analysis (RCWA) and verified with finite element method (FEM) analysis using commercial software to optimize the designs. Plane-wave excitation and periodic boundary conditions were used to simulate the reflections from the array. Periodic boundary conditions in the transverse directions were used to reduce the computational domain to a single cell, as shown in FIG. 9B. Period boundary conditions are also intended to allow for uniform distribution.

In the performed calculations, the substrate was chosen to be either bare or 30 nm thick aluminum (Al) coated Corning Eagle 2000 glass. The Al layer acts as a reflective mirror on top of the glass substrate. In a particular case, the Al layer may be selected or configured to have greater than 85% reflectivity over the visible spectrum. In addition, Al has good adhesion to glass and performs as a charge dissipating layer during electron beam lithography (EBL). Nano-patches were arranged in a square lattice array with a pitch of 400 nm. It will be understood that other arrangements of nano-patches may be used. Other heights of nano-patches may be used although the results may vary accordingly. The height of the patches was approximately 60 nm, and the width varied from 80 nm to 320 nm. FIGS. 9C and 9D show scanning electron microscope (SEM) images of two representative arrays with widths of 320 nm and 200 nm, respectively.

In order to understand the role of the reflective mirror below the nano-patches, the reflection spectra were simulated and compared for structures consisting of nano-patches on bare and Al-coated glass substrates. FIGS. 10A and 10B show the reflections for nano-patches with a width of 200 nm when the refractive index of the surrounding medium is changed from 1 (air) to 1.39. For the case of glass substrate, below the wavelength of 600 nm, over 60% of the signal is transmitted through the glass, with minimal reflection. As the incident wavelength is increased and the width of the patches becomes a smaller fraction of the wavelength, the entire structure acts like a solid metal and becomes highly reflective. With further increase in wavelength, reflections again reduce as the height of the nano-patch becomes a smaller fraction of the wavelength. This dynamic was confirmed by simulating a wider nano-patch where the peak for reflection increased to a longer wavelength and the spectrum became broader. The peak wavelength in the reflection spectrum for a given width of the nano-patches increases with increasing refractive index. A sensitivity of 89 nm/RIU can be achieved if one measures the spectral changes. A resonance minimum at 619 nm is observed for a refractive index of 1.3, but may not be very distinct because of low reflections for shorter wavelengths. Hence, changes of reflected colors in bright-field microscopy cannot be observed as easily. Conversely, with a strong back reflector, the reflection features, especially in the shorter visible range, become more pronounced as shown in FIG. 10B.

High reflections with broad frequency dependent features are observed below the wavelength of 500 nm. A sharp reduction in reflection creates a resonant dip at 566 nm for air. This sensor allows for the creation of the resonant dips not typically present in 2-D metallic gratings. Furthermore, this dip in the reflection shifts toward a longer wavelength if the refractive index increases. This minimum originates from the resonance due to the standing waves in the two-dimensional grating. This was confirmed by comparing the simulated reflection from a two-dimensional grating with that from thin film gold on an Al-coated substrate (see FIG. 17). For the 200 nm wide nano-patches, a sensitivity of 470 nm/RIU is realizable. Due to the refractive-index-dependent spectral features in the reflection spectrum being in the visible range, one may expect a change in the reflected colors from the arrays as the surrounding medium alters. Therefore, the proposed structure can be used for sensing either by measuring the spectral changes or by observing the changes in color. The color change can be used as a simple and cost effective way of sensing.

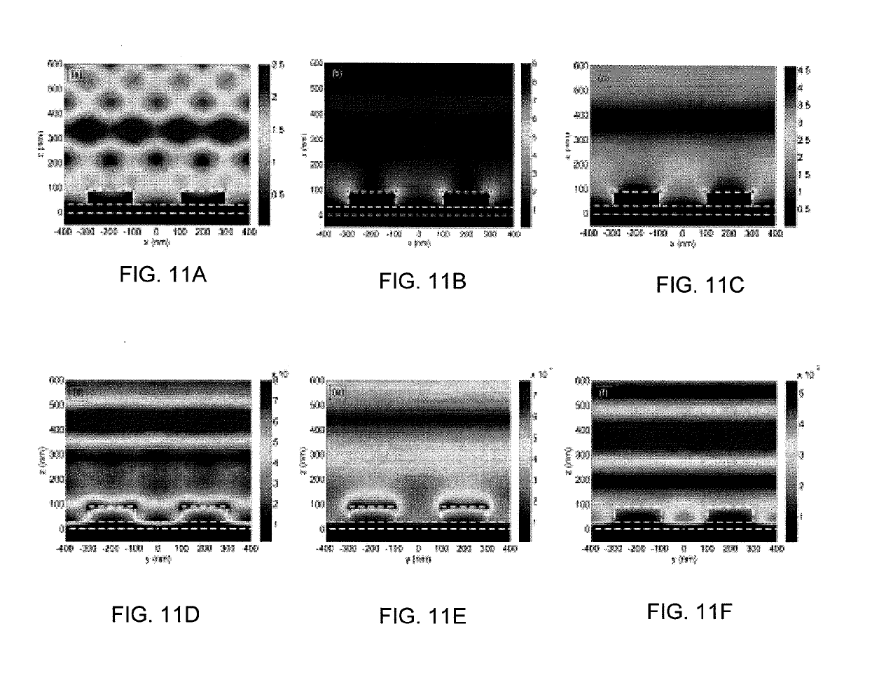

In order to further understand the performance of the structural colorimetric sensor (sometimes referred to as a colorimetric sensor), electric and magnetic field distributions of the surface Plasmon modes of the grating in the proposed structure are examined and discussed. FIGS. 11A to 11F shows the electric and magnetic field distributions for the 200 nm wide nano-patch at different excitation wavelengths. Input excitation is a plane-wave with electric field polarized along the x-direction. The amplitude of the incident electric field is 1. Amplitude of the total electric and magnetic fields are plotted in the x-z and y-z planes, respectively. The surrounding medium is air for all simulations. Total fields at the wavelength of 400 nm are plotted in FIG. 11A and diffraction of light due to the structure is clearly visible. The effect of the grating has also been studied using a focused beam excitation as detailed herein. As the wavelength is increased to 566 nm, as shown in FIGS. 11B and 11E, reflection markedly reduces because the field is strongly interacting with the gold nano-patches, thereby increasing the absorption. This interaction is clearer in the magnetic field distributions (FIG. 11E) which shows a highly localized field at the top surface of the nano-patches. The resonance is a result of excitation of surface Plasmon modes within the structure, which take away the energy from the incident signal. As the wavelength is further increased to 714 nm (FIGS. 11C and 11F), the overall structure becomes highly reflective.

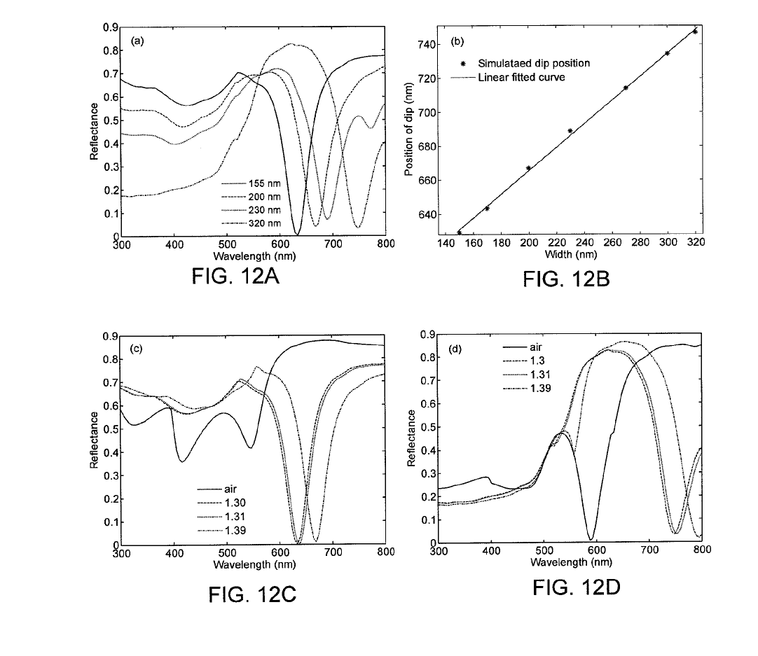

In order to achieve perceptible color change either by the naked eye or imagers, the sensor can be configured to reflect light within the 550-600 nm wavelength range as the transition from green to red color occurs in this range. The resonance dip can be tuned by adjusting the width of the nano-patch. This is shown in FIG. 12A for a number of widths varying from 155 nm to 320 nm. The wavelength of the spectral resonance dip increases with the width monotonically. The wavelength of the resonance is plotted as a function of nano-patch width in FIG. 12B showing a linear behavior, making it easy to optimize the dimensions.

FIGS. 12C and 12D plot the spectral changes for different surrounding medium refractive indices for widths of 155 nm and 320 nm, respectively. At 320 nm, while spectral changes are observed, they happen in the red region and perceptible color changes may not be observed by the naked eye. If instead of measuring color, the spectral features are measured, sensitivities of 393 nm/RIU, 449 nm/RIU and 532 nm/RIU are obtained for the widths of 155 nm, 230 nm and 320 nm, respectively. The increase in sensitivity with increase of width is expected as reduction in the gap between the nano-patches results in stronger electric field confinement within the gap. However, as the width is increased, for the specific period of 400 nm, less color change is detectable either by the naked eye or image processing and hence, for the purpose of making sensors using the color change, a smaller width may be more suitable. In some cases, a range of 120 nm to 270 nm may be selected, wherein the width may be chosen based on the material or medium to be observed.

In order to characterize the colorimetric sensing, Cargille index fluids of known refractive indices varying from 1.3 to 1.39 in steps of 0.01 were introduced within the arrays. Bright-field images were taken using a charged coupled device (CCD) camera mounted on a microscope using a halogen lamp light source.

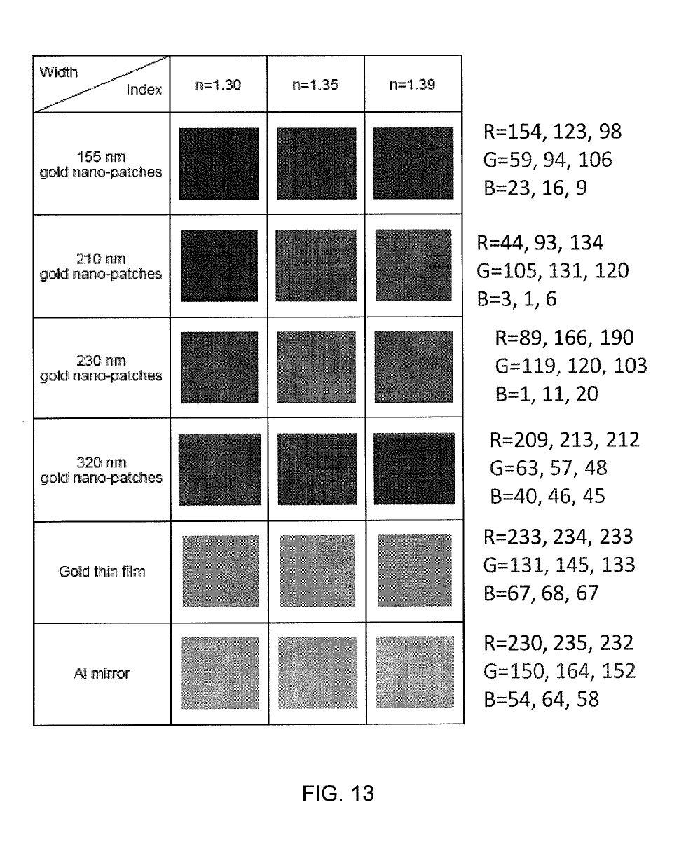

FIG. 13 shows images from different arrays for medium refractive indices of 1.3, 1.35 and 1.39. Images were also taken from the same thickness of thin film gold layer and the Al-coated glass substrate with no nano-patches, to highlight the differences. Remarkable perceptible changes are observed for the widths of 155 nm to 230 nm. Furthermore, the color change continuously goes through the visual spectrum, for example, for 155 nm, the change happens from reddish part of the spectrum to green while for 230 nm, it changes from green to rust color. The color spans a higher refractive index with a smaller width nano-patch, similar to that of a smaller refractive index with a larger width nano-patch (observed by comparing the diagonal elements in the FIG. 13). With the increase of both width and refractive index, the spectral resonance shifts to a longer wavelength. For the width of 320 nm, the red color dominates the image and less perceptible changes are observed. This is shown in the simulations in as described herein. The color changes for thin film gold and Al-coated glass substrates are minimal. These results further illustrate that the color changes are indeed due to the optimized two-dimensional metallic gratings. Refractive index resolution was calculated. The best refractive index resolution of 3×10⁻⁶ is achieved for the width of 155 nm and compares well with photonic sensors. This resolution is more than one order of magnitude better than the sensor embodiment with silicon nanowires. The color changes are also perceptible to the naked eye.

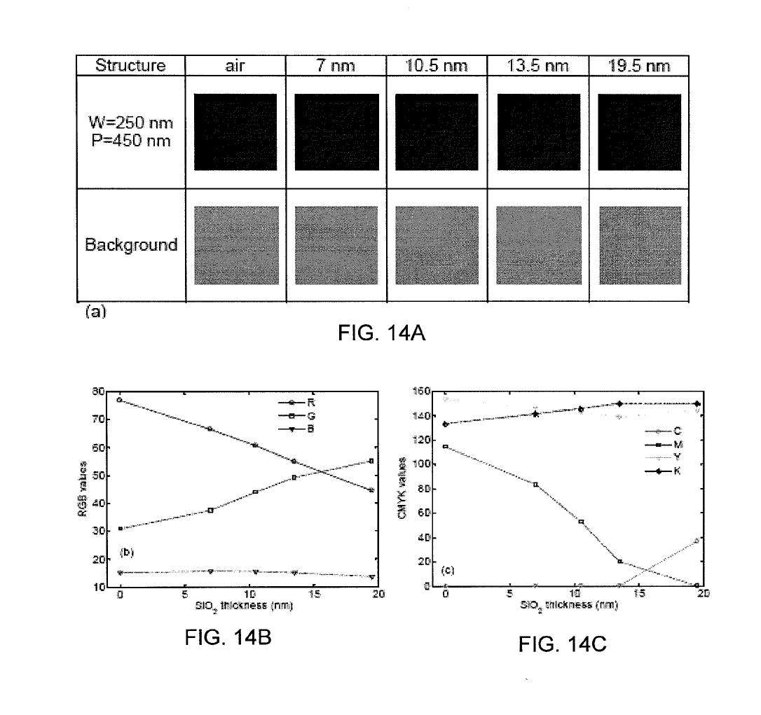

Experimentation has demonstrated the functionality of the colorimetric sensor for bulk sensing. For example, for biochemical sensing, detection of surface attachments can be very important. Experiments were conducted by depositing thin layers of silicon dioxide varying from 7 nm to 19.5 nm using plasma enhanced chemical vapor deposition (PECVD) and capturing the images. The thickness of silicon dioxide was measured using an optical interferometer at multiple places around the arrays. Measured variation in thickness was less than 0.5 nm. FIG. 14A plots the color changes as the silicon dioxide thickness is increased. For this array, the pitch was 450 nm and the width of the patch was 250 nm. The color changes in FIG. 14A are further detail in the graphs in FIGS. 14B and 14C. The top row illustrates gold nano-patches while the bottom row is for thin film gold on an Al coated substrate. Silicon dioxide was chosen because its refractive index is close to those of proteins and DNA. In these tests, color changes can generally be perceived by the naked eye when the thickness is changed by as little as 3 nm (from 10.5 nm to 13.5 nm). Images from the background are also shown and minimal color change is observed. This result is believed to demonstrate the effectiveness of the colorimetric sensor for surface sensing using a simple color imaging. The decomposed values of R, G, and B, and C, M, Y and K components are plotted in FIGS. 14B and 14C, respectively. If only one of the components of the image, for example R from RGB, or M from CMYK, and assuming a resolution of 1 in the component, a surfactant detectability of 7 Å and 2 Å can be achieved, respectively. Since biochemical materials are generally in the range of 1-4 nm long, the proposed sensor may be a promising tool for detecting bio-chemical reactions, such as, for example, hybridization of DNA and other.

While a specific embodiment of the sensor has been discussed, other variations of the implementation are possible, as will be apparent to a person skilled in the art. For example, instead of using gold for grating other metals like silver, chrome etc. may be used. The nano disks could be square, circular, ring shaped, crescents, triangular shapes, stars or other cross-sectional shapes and could be arranged in other lattices like triangular ones besides the square ones described here. The nanostructures are intended to be arranged in periodic structures to have localized surface plamonics. The reflective mirror at the bottom could be other metals besides Aluminum or also dielectric mirrors. Instead of using image processing, the reflected light may be coupled to a RGB splitter and sensing achieved by measuring the power in the output ports. The reflected light may be coupled to other color definitions, for example CMYK, or other image processing components.

Simulation of the reflection spectrum from two-dimensional metallic gratings was carried out using commercial software. Two different methods, rigorous coupled-wave analysis (RCWA) using R-SOFT (www.rsoftdesign.com) and finite element method (FEM) using HFSS (www.ansys.com) were employed to verify the calculations. The optical constants used for gold were extracted from Pollick.

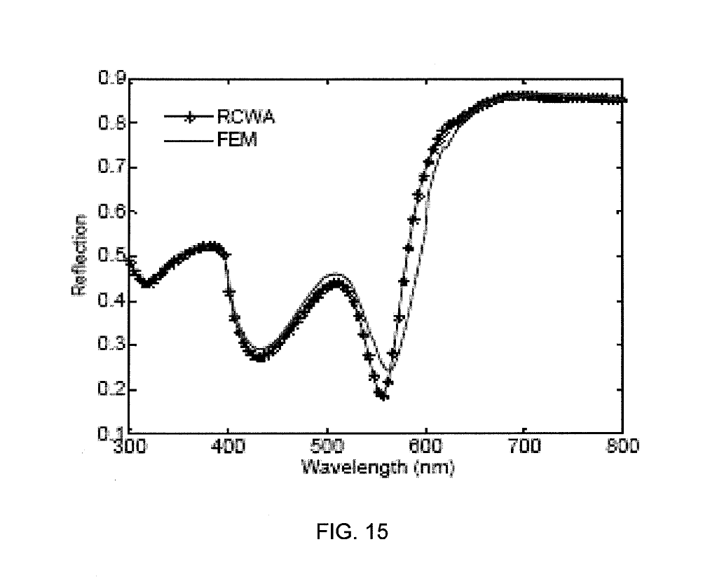

FIG. 15 shows comparison between the reflection spectra obtained from the two methods for a representative structure. Good agreement is achieved over the complete wavelength range validating the simulation results.

In a specific example, a Corning Eagle 2000 glass substrate was used as the substrate. Next, a 30 nm thick Al layer was deposited using an e-beam evaporator to use as a back-reflector and also as a charge dissipation layer during e-beam lithography. The wafer was spin-coated with 950 K PMMA A4 resist at a speed of 4000 rpm. Subsequently, the sample was baked for 20 minutes in a vacuum oven at 180° C. resulting in a final resist thickness of 200 nm. Electron beam exposure was carried out by a RAITH150-TWO machine operating at 25 kV. The exposed resist was then developed in a mixture of MIBK:IPA (1:3) at room temperature for 30 s, followed by dipping in IPA for 30 s, and dried using nitrogen. To improve the adhesion of gold onto Al, a 3 nm thick layer of titanium was deposited before deposition of 60 nm thick gold film by e-beam evaporator at deposition rate of 3 Å/s. Lift-off was achieved by soaking the sample overnight in a PG remover bath.

The reflective surface may be a metallic reflector. In some cases, greater than 70% reflectivity in the reflective surface is desirable. In other cases, greater than 85% reflectivity is achieved over the entire visible range. In some specific cases, the metallic reflector may be an Al layer which may also act like a charge dissipating layer during e-beam lithography over the glass substrate.

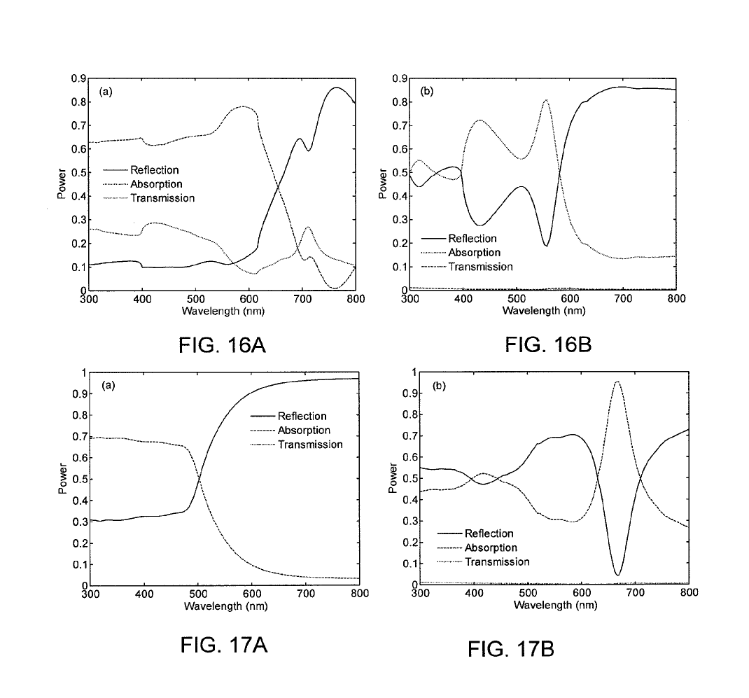

FIGS. 16A and 16B shows the transmission, reflection and absorption spectra for 200 nm wide gold nano-patches on a glass and Al-coated glass substrates as shown in FIG. 16A. For bare glass substrate, as shown in FIG. 16A, most of the light is transmitted through the substrate below wavelength of 600 nm. An absorption peak and corresponding reflection peaks are observed above a wavelength of 700 nm due to surface Plasmon excitation. By using an Al mirror as shown in FIG. 16B, the reflection at shorter wavelength increases as the light which was previously passing through the arrays is reflected by the mirror. Increased absorption due to confinement of electric field at 566 nm creates a minimum in the reflection resulting in the reflected colors.

In order to confirm the reflection spectrum is indeed due to the periodic nature of gold nano-patches, simulations were also conducted for thin film gold and are compared with nano-patches on Al-coated glass substrate. Reflection, absorption and transmission spectrum are shown in FIGS. 17A and 17B. Resonances are only observed for the nano-patches thereby confirming the role played by the two dimensional grating. These simulation results were confirmed in the experiments where the color did not change appreciably for thin film gold by changing the refractive index of surrounding medium.

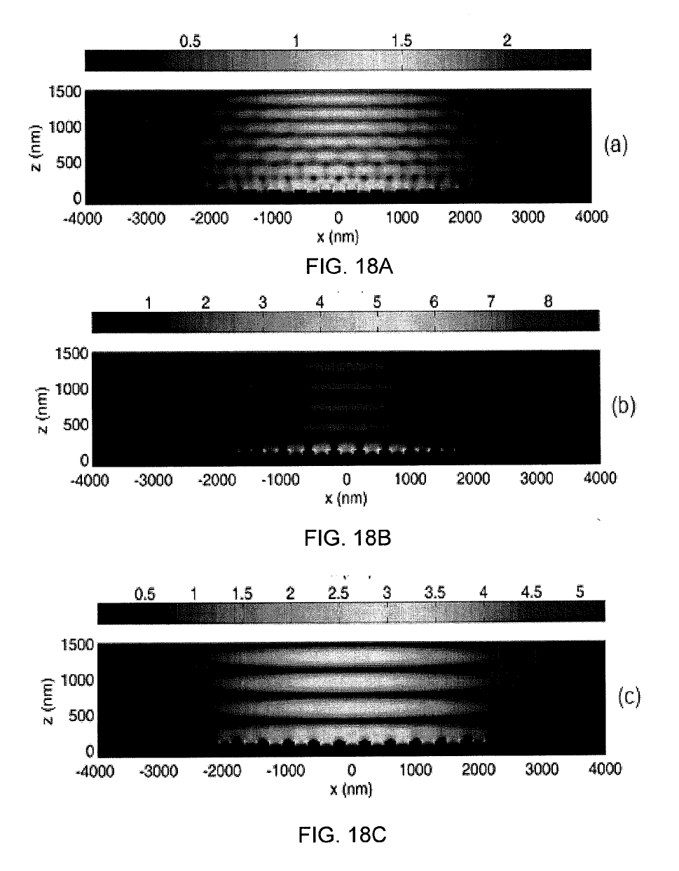

In order to understand the different regions of the reflection spectrum, simulations were also conducted with a focused Gaussian beam with full width at half maximum (FWHM) of 2.65 μm incident upon the nano-patches. These results are shown in FIGS. 18A to 18C for three different wavelengths where the total electric field distributions are plotted for a cross-section of the device. At a wavelength of 400 nm in FIG. 18A, diffraction orders from the 2-dimensional grating orders are observed in the reflection, confirming that the device is acting like a grating. When the wavelength is increased to 566 nm, in FIG. 18B highly localized electric field around the nano-patches is observed resulting in increased loss and reduced reflections. When the wavelength is further increased to 714 nm, in FIG. 18C the electric field is perturbed less by the gold nano-patches resulting in reflection from the Al mirror becomes dominant. These results support the plane wave simulations shown in the paper.

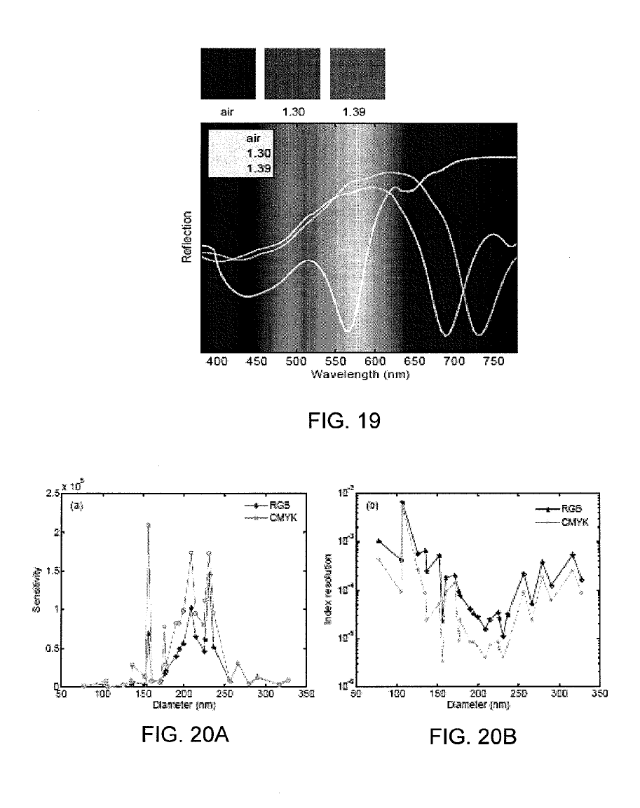

The ability to adjust the position of the dip is conceptually shown in FIG. 19 which plots the visible spectrum of light versus wavelength. Overlaid on top is the simulated reflection spectra for 230 nm wide nano-patches for surrounding medium indices of 1 (air), 1.3 and 1.39. Also illustrated are the bright-field images taken of the array with an optical microscope. When the array is surrounded by air, most of the reflection is observed in the longer wavelength region and the array indeed looks red. As the refractive index is increased to 1.3, reflections are reduced in the red region and the array turns green. By further changing the refractive index to 1.39, the spectral dip is red-shifted and red components intensify. The reflected color of the array starts to look like rust or copper like. By creating spectral features around 600 nm wavelength, color changes can be more easily perceived, both by imaging devices and by the naked eye.

The images were decomposed into their RGB components using the additive RGB model and sensitivity of the sensor was calculated and is shown in FIG. 20A. Furthermore, the subtractive CMYK model with equal weightings for each color was also used as it was found to provide better repeatability in image processing. To evaluate the repeatability of measurements and experiments conducted, the color due to the same refractive index fluid was measured 8 different times. Standard deviation in the measured sensitivity was 0.34 and 0.8 for the CMYK and RGB models, respectively. Refractive index resolution was calculated as twice the standard deviation divided by the sensitivity as shown in FIG. 20B.

In the preceding description, for purposes of explanation, numerous details are set forth in order to provide a thorough understanding of the embodiments. However, it will be apparent to one skilled in the art that these specific details may not be required. In other instances, well-known structures are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A colorimetric sensor comprising:
a substrate; and
a periodic array of nanostructures provided to the substrate, wherein the periodic array of nanostructures is configured to provide a change in color based on a medium that is within a predetermined distance of the colorimetric sensor.

2. The colorimetric sensor of claim 1 wherein the periodic array of nanostructures is comprised of semiconductor nanowires.

3. The colorimetric sensor of claim 2 wherein the providing a change in color results from optical wave-guiding in the semiconductor nanowires.

4. The colorimetric sensor of claim 1 wherein the periodic array of nanostructures comprises a metallic refraction grating formed by metallic nanostructures.

5. The colorimetric sensor of claim 4 wherein the providing a change in color results from surface Plasmon resonance among the periodic array of nanostructures.

6. The colorimetric sensor of claim 4 wherein the providing a change in color results from a dip in the reflection spectrum at a predetermined wavelength based on characteristics of the periodic array of nanostructures.

7. The colorimetric sensor of claim 4 wherein the colorimetric sensor is transmissive.

8. A colorimetric sensor comprising:
a substrate;
a reflective surface provided to the substrate; and
a periodic array of nanostructures provided to the reflective surface, wherein the periodic array is configured to provide a change in reflected color based on a medium within a predetermined distance of the colorimetric sensor.

9. The colorimetric sensor of claim 8 wherein the periodic array is comprised of metallic nanostructures.

10. The colorimetric sensor of claim 9 wherein the providing a change in reflected color results from surface Plasmon resonance among the periodic array of metallic nanostructures.

11. The colorimetric sensor of claim 9 wherein the providing a change in reflected color results from a dip in the reflection spectrum at a predetermined wavelength based on characteristics of the periodic array of nanostructures.

12. The colorimetric sensor of claim 9 wherein the nanostructures have a spacing in a range of approximately 250 nm to 750 nm and a width in a range of approximately 20% to 80% of the spacing.

13. The colorimetric sensor of claim 9 wherein the nanostructures have a height in a range of approximately 30 nm to 300 nm.

14. The colorimetric sensor of claim 8 wherein the periodic array is configured such that a color resulting from the change in reflected color is visible to the naked eye.

15. The colorimetric sensor of claim 8 wherein the periodic array is configured such that a color resulting from the change in reflected color is at a wavelength between approximately 500 nm and 700 nm.

16. The colorimetric sensor of claim 8 wherein the predetermined distance is less than approximately 100 nm.

17. The colorimetric sensor of claim 8 wherein the reflective surface is metallic and provides a π phase shift.

18. The colorimetric sensor of claim 8 wherein the reflective surface is on the substrate and the periodic array of nanostructures is on the reflective surface.

19. A colorimetric sensor comprising:
a substrate;
a metallic reflective surface provided to the substrate; and
a periodic grid of nanostructures provided to the reflective surface, wherein the periodic grid has a spacing of approximately 400 nm and the nanostructures have a width of approximately 150 nm.
